(19) United States
(12) Patent Application Publication
(10) Pub. No.: US 2022/0158474 A1
(43) Pub. Date: May 19, 2022

(54) SENSOR DEVICE

(71) Applicant: Mitsubishi Electric Corporation, Tokyo (JP)

(72) Inventor: Mitsuru KITAZAKI, Tokyo (JP)

(21) Appl. No.: 17/430,189

(22) PCT Filed: Apr. 15, 2019
(86) PCT No.: PCT/JP2019/016162

§ 371 Date: Aug. 11, 2021

(51) Int. Cl. H02J 7/34; H02J 7/00; H02J 13/00; H01M 10/42

(52) U.S. Cl. CPC H02J 7/34; H02J 7/0063; H01M 10/48; H02J 13/00001; H01M 10/425; H02J 7/0068

(57) ABSTRACT

A sensor device includes: a primary battery; a secondary battery that is charged by energy harvesting; a sensor that is operated by electricity supplied from the primary battery or from the secondary battery; a source-of-electricity switching circuit that switches a source of electricity for the sensor between the primary battery and the secondary battery; a notification unit that makes a notification indicating information; and a controller that controls the sensor and the notification unit. The source-of-electricity switching circuit switches the source of electricity to the primary battery when a voltage of the secondary battery falls below a predetermined first reference voltage in the case where the source of electricity is the secondary battery. The controller causes the notification unit to make a notification indicating that an operation of the secondary battery is unstable, when the voltage of the secondary battery falls below the first reference voltage.

### TECHNICAL FIELD

The present disclosure relates to a sensor device having an energy harvesting capacity.

### BACKGROUND ART

In recent years, energy harvesting sensors have attracted increasing attention, since the energy harvesting sensors are powered by electricity obtained from energy from external sources to reduce electricity consumption. The energy harvesting is known as a technique of collecting energy that comes from solar light, illuminating rays, vibrations generated by machines, heat, or other sources, and obtaining electricity from such energy. In such energy harvesting, it is possible to convert a very small amount of ambient energy into electricity, and use the electricity.

Energy harvesting sensor devices are expected to be used in various fields. In order that an energy harvesting sensor device be used in various fields, the energy harvesting sensor device needs to be compatible with a plurality of types of power supplies. In view of this point, sensor devices each of which is compatible with a plurality of types of power supplies have been proposed (see, for example, Patent Literature 1).

A sensor device described in Patent Literature 1 includes a battery that supplies a sensor with electricity, a dye-sensitized solar cell (DSC) unit that is an external electricity supply unit that supplies the sensor with electricity produced by a solar cell, a source-of-electricity switching unit that switches the source of electricity for the sensor between the battery and the DSC unit, and a source-of-electricity control unit that controls the source-of-electricity switching unit. The source-of-electricity control unit performs a control to switch the source of electricity to the DSC unit when a voltage of the DSC unit, which is an energy harvesting unit, satisfies a predetermined reference voltage criterion, and switch the source of electricity to the battery when the voltage of the DSC unit does not satisfy the predetermined reference voltage criterion.

### CITATION LIST

### Patent Literature

Patent Literature 1: International Publication No. 2018/168848

### SUMMARY OF INVENTION

### Technical Problem

However, in the sensor device described in Patent Literature 1, it is impossible to externally determine whether the source of electricity for the sensor is the energy harvesting unit or the battery, and also impossible to recognize an unstable operation of the energy harvesting unit. Therefore, it is not possible to determine, for example, whether the sensor is set in an optimal environment for energy harvesting.

The present disclosure is applied to solve the above problems, and relates to a sensor device that enables a user to recognize an unstable operation of a secondary battery, which is to be charged by energy harvesting.

### Solution to Problem

A sensor device according to an embodiment of the present disclosure includes a primary battery, a secondary battery that is charged by energy harvesting; a sensor that is operated by electricity supplied from the primary battery or from the secondary battery; a source-of-electricity switching circuit that switches a source of electricity for the sensor between the primary battery and the secondary battery; a notification unit that makes a notification indicating information; and a controller that controls the sensor and the notification unit. The source-of-electricity switching circuit switches the source of electricity to the primary battery when a voltage of the secondary battery falls below a predetermined first reference voltage in the case where the source of electricity is the secondary battery. The controller causes the notification unit to make a notification indicating that an operation of the secondary battery is unstable, when the voltage of the secondary battery falls below the first reference voltage.

A sensor device according to another embodiment of the present disclosure includes: a primary battery; a secondary battery that is charged by energy harvesting; a sensor that is operated by electricity supplied from the primary battery or from the secondary battery; a source-of-electricity switching circuit that switches a source of electricity for the sensor between the primary battery and the secondary battery; a wireless communication unit that wirelessly communicates with an external device and transmit information to be indicated by a notification that the external device is caused to make; and a controller that controls the sensor and the wireless communication unit, The source-of-electricity switching circuit switches the source of electricity to the primary battery when a voltage of the secondary battery falls below a predetermined first reference voltage in the case where the source of electricity is the secondary battery. The controller causes the external device to make a notification indicating that an operation of the secondary battery is unstable, when the voltage of the secondary battery falls below the first reference voltage.

### Advantageous Effects of Invention

In each of the sensor devices according to embodiments of the present disclosure, when the voltage of the secondary battery falls below the first reference voltage, the controller causes the notification unit or the external device to make a notification indicating that the operation of the secondary battery is unstable. Thus, a user can recognize that the operation of the secondary battery, which is to be charged by energy harvesting, is unstable.

### BRIEF DESCRIPTION OF DRAWINGS

FIG. 1 illustrates a configuration of a sensor device according to Embodiment 1.

FIG. 2 is an explanatory view for an energy harvesting unit according to Embodiment 1.

FIG. 3 indicates a control flow of a control by the sensor device according to Embodiment 1.

FIG. 4 indicates a control flow of a control by a sensor device according to Embodiment 2.

FIG. 5 indicates a control flow of a control by a first modification of the sensor device according to Embodiment 2.

FIG. 6 indicates a control flow of a control by a second modification of the sensor device according to Embodiment 2.

FIG. 7 indicates a control flow of a control by a third modification of the sensor device according to Embodiment 2.

FIG. 8 indicates a control flow of a control by a sensor device according to Embodiment 3.

FIG. 9 indicates a control flow of a control by a sensor device according to Embodiment 4.

### DESCRIPTION OF EMBODIMENTS

Embodiments will be described with reference to the drawings. The following descriptions concerning the embodiments are not limiting. In addition, in figures which will be referred to below, relationships in size between components may sometimes differ from actual ones.

### Embodiment 1

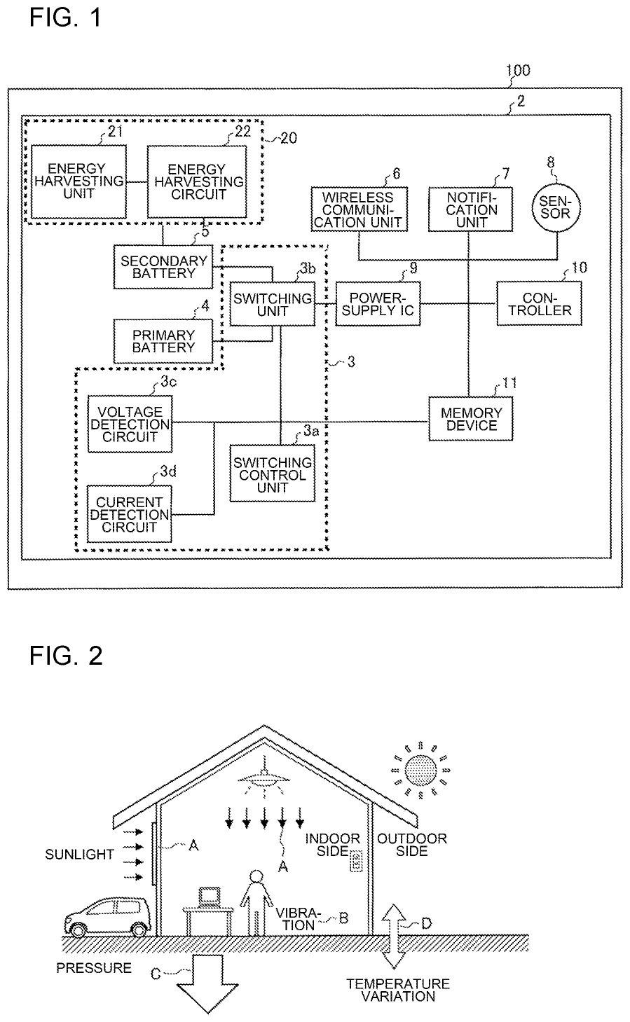

FIG. 1 illustrates a configuration of a sensor device 100 according to Embodiment 1. The sensor device 100 according to Embodiment 1 includes a sensor device board 2 as illustrated in FIG. 1. A primary battery 4, a secondary battery 5, an energy harvesting module 20, a source-of-electricity switching circuit 3, a power-supply integrated circuit (IC) 9, a controller 10, a memory device 11, a wireless communication unit 6, a notification unit 7, and a sensor 8 are mounted on or in the sensor device board 2. It should be noted that in Embodiment 1, the sensor device 100 includes both the wireless communication unit 6 and the notification unit 7; however, this is merely an example, and the sensor device 100 may include only one of the wireless communication unit 6 and the notification unit 7.

The primary battery 4 is a disposable battery, and is, for example, a lithium battery. The positive pole of the primary battery 4 is connected to the source-of-electricity switching circuit 3, and the negative pole of the primary battery is grounded.

The energy harvesting module 20 performs energy harvesting and supplies electricity obtained by the energy harvesting to the secondary battery 5. The energy harvesting module 20 includes an energy harvesting unit 21 and an energy harvesting circuit 22. The energy harvesting unit 21 performs energy harvesting. The energy harvesting circuit 22 converts a voltage value of electricity obtained by the energy harvesting performed by the energy harvesting unit 21, and the secondary battery 5 is charged with the electricity whose voltage value is converted.

FIG. 2 is an explanatory view for the energy harvesting unit 21 according to Embodiment 1, As the energy harvesting unit 21, a unit that uses such an energy source as illustrated in FIG. 2 can be considered. To be more specific, the energy harvesting unit 21 is a visible-light harvesting unit that uses sunlight or white light-emitting diode (LED) illumination as an energy source denoted by A, a vibration harvesting unit that uses vibration as an energy source denoted by B, a piezoelectric energy harvesting unit that uses a pressure as an denoted by C, and a temperature-variation energy harvesting unit that uses temperature variations as an energy source denoted by D.

The secondary battery 5 is a rechargeable battery, and is, for example, a lithium ion capacitor. The positive pole of the secondary battery 5 is connected to the source-of-electricity switching circuit 3 and the energy harvesting module 20, and the negative pole of the secondary battery 5 is grounded. The secondary battery 5 is charged with electricity supplied from the energy harvesting module 20. That is, the secondary battery 5 is charged with electricity obtained by energy harvesting.

The source-of-electricity switching circuit 3 is connected to the primary battery 4, the secondary battery 5, and the power-supply IC 9, and switches electricity to be supplied to the power-supply IC 9 between electricity from the primary battery 4 and electricity from the secondary battery 5. That is, the source-of-electricity switching circuit 3 switches the source of electricity for the power-supply IC 9 between the primary battery 4 and the secondary battery 5.

The source-of-electricity switching circuit 3 includes a switching control unit 3a, a switching unit 3b, a voltage detection circuit 3c, and a current detection circuit 3d. The switching unit 3b switches the source of electricity for the power-supply IC 9 between sources of electricity. The switching control unit 3a controls the switching unit 3b. The voltage detection circuit 3c detects a voltage of the primary battery 4 and that of the secondary battery 5. The current detection circuit 3d detects current that flows from the primary battery 4 and current that flows from the secondary battery 5.

The power-supply IC 9 supplies electricity supplied from the primary battery 4 or from the secondary battery 5 to the controller 10, the memory device 11, the sensor 8, the notification unit 7, and the wireless communication unit 6. The power-supply IC 9 has a function of stabilizing a supply voltage, and is a supply-voltage stabilizing power supply, such as a DC-DC converter or a low drop out (LDO).

The wireless communication unit 6 is an interface capable of transmitting and receiving a digital or analog signal. The wireless communication unit 6 wirelessly communicates with an external device, such as a remote control unit or a smartphone, and includes a communication module that is compliant with a communication standard such as Wi-Fi (registered trademark) or Bluetooth (registered trademark).

The controller 10 controls the sensor 8, the notification unit 7, and the wireless communication unit 6. The controller 10 is, for example, dedicated hardware or a central processing unit (CPU) (also referred to as a central processing device, a processing device, a computing device, a microprocessor, or a processor) that executes a program stored in the memory device 11.

In the case where the controller 10 is dedicated hardware, the controller 10 is, for example, a single circuit, a compound circuit, an application specific integrated circuit (ASIC), a field-programmable gate array (FPGA), or a combination of these circuits. Functions to be fulfilled by the controller 10 may be fulfilled by respective hardware, or may be fulfilled by single hardware.

In the case where the controller 10 is a CPU, functions to be fulfilled by the controller 10 is fulfilled by software, firmware, or a combination of software and firmware. The software and firmware are described as programs and stored in the memory device 11. The CPU fulfills the functions of the controller 10 by reading and executing the programs stored in the memory device 11.

It should be noted that some of the functions of the controller 10 may be fulfilled by dedicated hardware, and others of the functions may be fulfilled by software or firmware.

The memory device 11 stores various kinds of information. The memory device 11 includes a non-volatile semiconductor memory that allows data to be rewritten, and in which the data is not erased even after the memory device 11 is subjected to a RESET process, which will be described below, to enter the initial state. As examples of the non-volatile semiconductor memory, a flash memory, an erasable programmable read-only memory (EPROM), and an electrically erasable programmable read-only memory (EEPROM) are present. In addition to the semiconductor memory described above, the memory device 11 may include, for example, a non-volatile semiconductor memory that does not allow data to be rewritten, such as a read-only memory (ROM), or a volatile semiconductor memory that allows data to be rewritten, such as a random-access memory (RAM).

The notification unit 7 notifies, for example, a user who is present in the outside, of various kinds of information regarding the sensor device 100, using, for example, light or sound. The notification unit 7 is, for example, an LED, a liquid crystal display, a buzzer, or a speaker. For example, a display unit of an external device may be used to make a notification indicating various kinds of information regarding the sensor device 100, for the user who is present in the outside. In such a case, the sensor device 100 may be formed without including the notification unit 7. In such a configuration, the wireless communication unit 6 transmits various kinds of information to the external device, and various kinds of information regarding the sensor device 100 are indicated for the user by, for example, the display unit of the external device.

The sensor 8 outputs the result of detection to the controller 10. The sensor 8 is, for example, a temperature sensor that detects a temperature, a humidity sensor that detects a humidity, a magnetic sensor that detects magnetism, and an atmospheric sensor that detects an atmospheric pressure.

In the sensor device 100, in the case where the source of electricity for the power-supply IC 9 is the secondary battery 5, when electricity production by the energy harvesting unit 21 is not sufficient, the secondary battery 5 cannot be sufficiently charged. In such a case, the electricity for stably sensing by the controller 10 using the sensor 8 cannot be supplied from the power-supply IC 9 to the controller 10 or the sensor 8, and stable sensing cannot be performed.

Thus, in the sensor device 100 according to Embodiment 1, when the power-supply IC 9 cannot supply sufficient electricity to the controller 10 or the sensor 8, the source of electricity for the power-supply IC 9 is switched to the primary battery 4 by the source-of-electricity switching circuit 3. Therefore, in the sensor device 100, the electricity required for stable sensing by the controller 10 using the sensor 8 can be supplied from the power-supply IC 9 to the controller 10 and the sensor 8, and stable sensing can thus be performed at all times.

Furthermore, in the sensor device 100, in the case where the source of electricity for the power-supply IC 9 is the primary battery 4, when sufficient electricity generation by the energy harvesting unit 21 becomes possible, the source of electricity for the power-supply IC 9 is switched to the secondary battery 5 by the source-of-electricity switching circuit 3. Therefore, the sensor device 100 can reduce the electricity consumption of the primary battery 4,

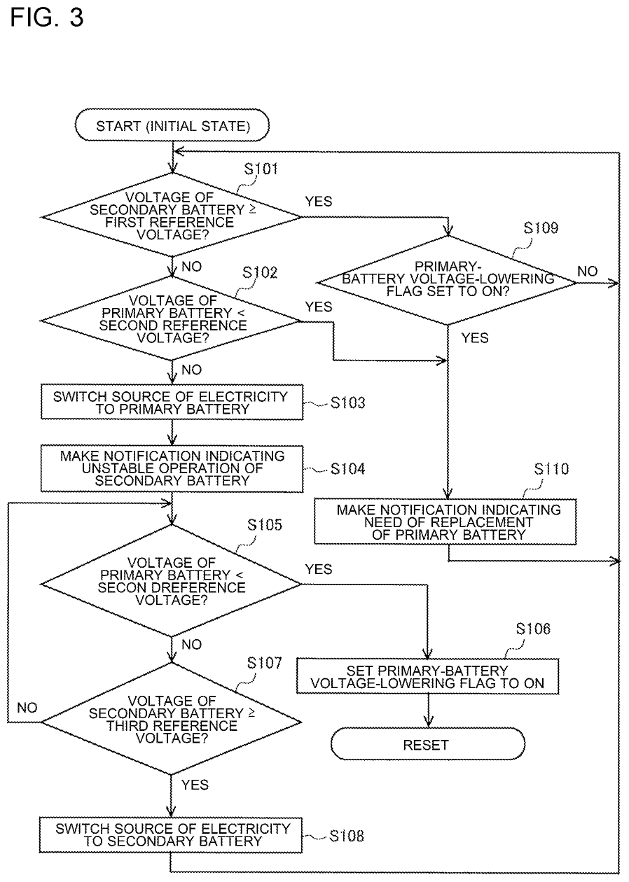

FIG. 3 indicates a control flow of a control by the sensor device 100 according to Embodiment 1. Next, the control by the sensor device 100 according to Embodiment 1 will be described in detail with reference to FIG. 3.

In the initial state, the source of electricity for the power-supply IC 9 is the secondary battery 5.

### (Step S101)

The source-of-electricity switching circuit 3 determines whether the voltage of the secondary battery 5 is higher than or equal to a predetermined first reference voltage or not. When the source-of-electricity switching circuit 3 determines that the voltage of the secondary battery 5 is higher than or equal to the first reference voltage (YES), the process proceeds to the process of step S109. In contrast, when the source-of-electricity switching circuit 3 determines that the voltage of the secondary battery 5 is neither higher than nor equal to the first reference voltage (NO), the process proceeds to the process of step S102. The first reference voltage is a voltage value that is determined based on a voltage required for stable sensing by the controller 10 using the sensor 8.

### (Step S102)

The source-of-electricity switching circuit 3 determines whether the voltage of the primary battery 4 is lower than a predetermined second reference voltage or not. When the source-of-electricity switching circuit 3 determines that the voltage of the primary battery 4 is lower than the second reference voltage (YES), the process proceeds to the process of step S110. In contrast, when the source-of-electricity switching circuit 3 determines that the voltage of the primary battery 4 is not lower than the second reference voltage (NO), the process proceeds to the process of step S103. The second reference voltage is another voltage value that is determined based on the voltage required for stable sensing by the controller 10 using the sensor 8.

### (Step S103)

The source-of-electricity switching circuit 3 switches the source of electricity for the power-supply IC 9 from the secondary battery 5 to the primary battery 4.

### (Step S104)

The controller 10 causes the notification unit 7 or an external device that is connected to the wireless communication unit 6 to make a notification to the effect that the operation of the secondary battery 5 is unstable. This notification is, for example, indication of the message “[t]he primary battery is in use because the operation of the secondary battery is unstable.” It should be noted that both the notification unit 7 and the external device may be caused to make the above notification.

### (Step S105)

The source-of-electricity switching circuit 3 determines whether the voltage of the primary battery 4 is lower than the predetermined second reference voltage or not. When the source-of-electricity switching circuit 3 determines that the voltage of the primary battery 4 is lower than the second reference voltage (YES), the process proceeds to the process of step S106. In contrast, when the source-of-electricity switching circuit 3 determines that the voltage of the primary battery 4 is not lower than the second reference voltage (NO), the process proceeds to the process of step S107.

### (Step S106)

The source-of-electricity switching circuit 3 sets a primary-battery voltage lowering flag to ON. Then, the sensor device 100 is subjected to a RESET process to enter the initial state. It should be noted that in an initial setting, the primary-battery voltage lowering flag is set to OFF. The information of the primary-battery voltage lowering flag is stored in the non-volatile semiconductor memory in the memory device 11.

### (Step S107)

The source-of-electricity switching circuit 3 determines whether the voltage of the secondary battery 5 is higher than or equal to a predetermined third reference voltage or not. When the source-of-electricity switching circuit 3 determines that the voltage of the secondary battery 5 is higher than or equal to the third reference voltage (YES), the process proceeds to the process of step S108. In contrast, when the source-of-electricity switching circuit 3 determines that the voltage of the secondary battery 5 is neither higher than nor equal to the third reference voltage (NO), the process returns to the process of step S105. Although the third reference voltage and the first reference voltage may be equal to each other or different from each other, in the case where the third reference voltage is set to a value higher than the first reference voltage, it is possible can reduce the frequency of switching the source of electricity for the power-supply IC 9 between the primary battery 4 and the secondary battery 5.

### (Step S108)

The source-of-electricity switching circuit 3 switches the source of electricity for the power-supply IC 9 from the primary battery 4 to the secondary battery 5.

### (Step S109)

The controller 10 determines whether the primary-battery voltage lowering flag is set to ON or not. When the controller 10 determines that the primary-battery voltage lowering flag is set to ON (YES), the process proceeds to the process of step S110, In contrast, when the controller 10 determines that the primary-battery voltage lowering flag is set to OFF (NO), the process returns to the process of step S101.

### (Step S110)

The controller 10 causes the notification unit 7 or the external device, which is connected to the wireless communication unit 6, to make a notification to the effect that the primary battery 4 needs to be replaced. This notification is, for example, indication of the message “[p]lease replace the primary battery because it is exhausted.” It should be noted that both the notification unit 7 and the external device may be caused to make the above notification.

After the primary battery 4 is replaced, the primary-battery voltage lowering flag is set to OFF.

As described above, the sensor device 100 according to Embodiment 1 includes the primary battery 4, the secondary battery 5, which is charged by energy harvesting, and the sensor 8, which is powered by electricity supplied from the primary battery 4 or from the secondary battery 5. The sensor device 100 also includes: the source-of-electricity switching circuit 3 that switches the source of electricity for the sensor 8 between the primary battery 4 and the secondary battery 5; the notification unit 7 that makes a notification indicating information; and the controller 10 that controls the sensor 8 and the notification unit 7. In the case where the source of electricity is the secondary battery 5, when the voltage of the secondary battery 5 falls below the predetermined first reference voltage, the source-of-electricity switching circuit 3 switches the source of electricity to the primary battery 4. In addition, when the voltage of the secondary battery 5 falls below the first reference voltage, the controller 10 causes the notification unit 7 to make a notification to the effect that the operation of the secondary battery 5 is unstable.

Furthermore, the sensor device 100 according to Embodiment 1 includes the primary battery 4, the secondary battery 5, which is charged by energy harvesting, and the sensor 8 that is powered by electricity supplied from the primary battery 4 or from the secondary battery 5. The sensor device 100 also includes: the source-of-electricity switching circuit 3, which switches the source of electricity for the sensor 8 between the primary battery 4 and the secondary battery 5; the wireless communication unit 6, which wirelessly communicates with an external device and transmits various kinds of information to the external device; and the controller 10, which controls the sensor 8 and the wireless communication unit 6. In the case where the source of electricity is the secondary battery 5, when the voltage of the secondary battery 5 falls below the predetermined first reference voltage, the source-of-electricity switching circuit 3 switches the source of electricity to the primary battery 4. In addition, when the voltage of the secondary battery 5 falls below the first reference voltage, the controller 10 causes the notification unit 7 and the external device to make a notification to the effect that the e operation of the secondary battery 5 is unstable.

In the sensor device 100 according to Embodiment 1, when the voltage of the secondary battery 5 falls below the first reference voltage, the controller 10 causes the notification unit 7 or the external device to make a notification to the effect that the operation of the secondary battery 5 is unstable. Thus, the user can know that the operation of the secondary battery 5, which is to be charged by energy harvesting, is unstable. Also, the user can recognize, for example, whether the sensor device 100 is set in an optimal environment for energy harvesting.

Furthermore, in the sensor device 100 according to Embodiment 1, in the case where the source of electricity is the secondary battery 5, when the voltage of the primary battery 4 is lower than the predetermined second reference voltage, the controller 10 causes the notification unit 7 or the external device to make a notification to the effect that the secondary battery 5 needs to be replaced.

In the sensor device 100 according to Embodiment 1, in the case where the source of electricity is the secondary battery 5, when the voltage of the primary battery 4 is lower than the second reference voltage, the controller 10 causes the notification unit or the external device to make a notification to the effect that the primary battery needs to be replaced. Thus, even when the sensor device 100 cannot be operated using the primary battery 4, if the sensor device 100 can be operated using the secondary battery 5, it is possible to make a notification to the effect that the primary battery 4 needs to be replaced. In addition, it is possible to know timing at which the primary battery 4 should be replaced, and to replace the primary battery 4, and it is therefore also possible to reduce the frequency of replacement of the primary battery 4.

### Embodiment 2

Regarding Embodiment 2, of the descriptions made regarding Embodiment 1, descriptions that can also be applied to Embodiment 2 will not be repeated, and components that are the same as or equivalent to those in Embodiment 1 will be denoted by the same reference signs.

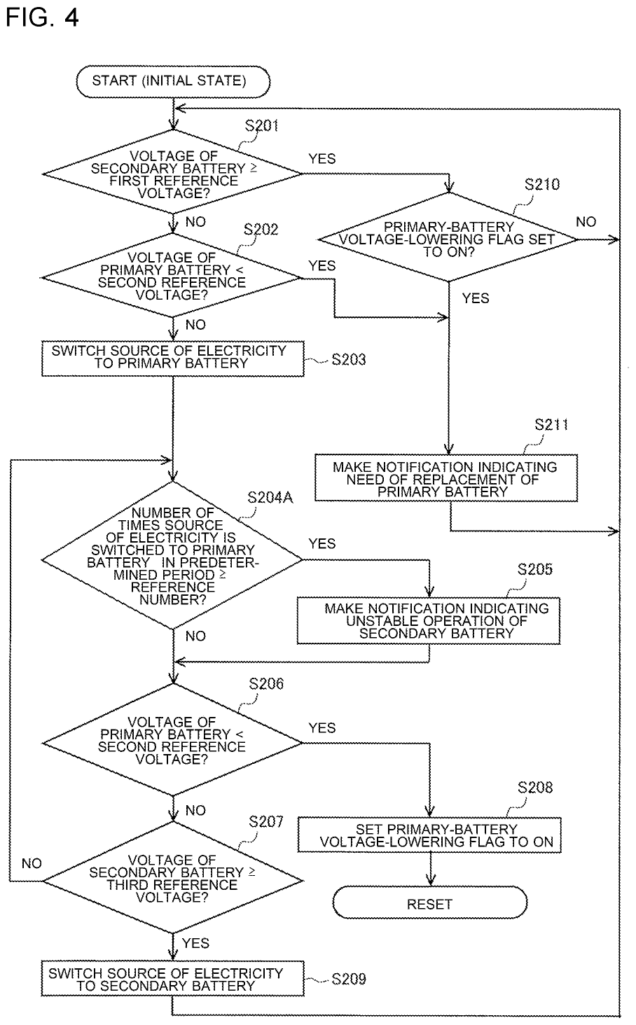

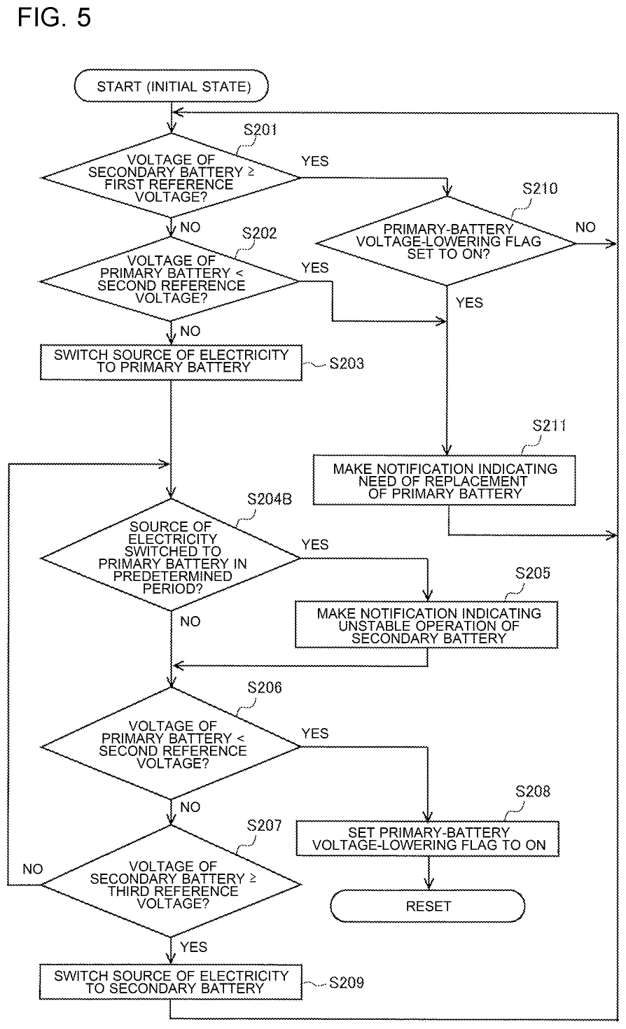

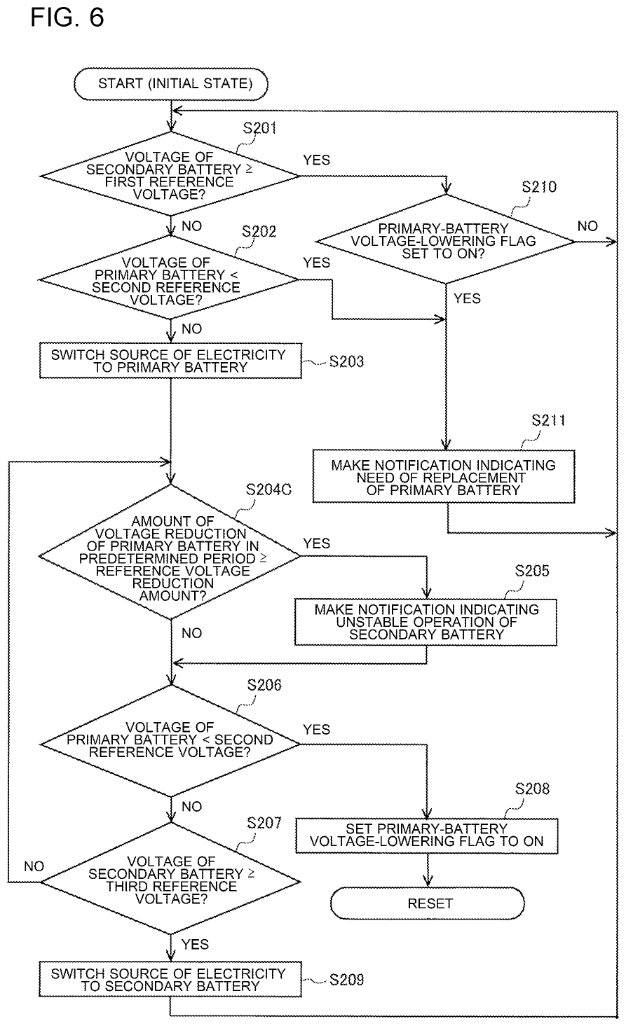

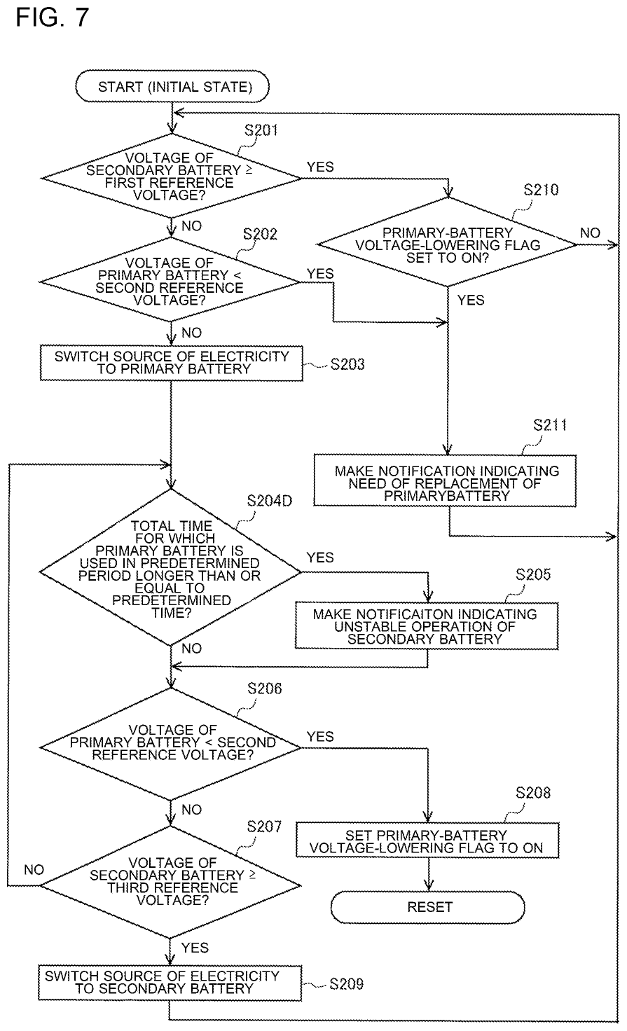

FIG. 4 indicates a control flow of a control by a sensor device 100 according to Embodiment 2. FIG. 5 indicates a control flow of a control by a first modification of the sensor device 100 according to Embodiment 2. FIG. 6 indicates a control flow of a control by a second modification of the sensor device 100 according to Embodiment 2. FIG. 7 indicates a control flow of a control by a third modification of the sensor device 100 according to Embodiment 2.

The control by the sensor device 100 according to Embodiment 2 will be described in detail with reference to FIGS. 4 to 7.

In the initial state, the source of electricity for the power-supply IC 9 is the secondary battery 5.

### (Step S201)

The source-of-electricity switching circuit 3 determines whether the voltage of the secondary battery 5 is higher than or equal to a predetermined first reference voltage or not. When the source-of-electricity switching circuit 3 determines that the voltage of the secondary battery 5 is higher than or equal to the first reference voltage (YES), the process proceeds to the process of step S210. In contrast, when the source-of-electricity switching circuit 3 determines that the voltage of the secondary battery 5 is neither higher than nor equal to the first reference voltage (NO), the process proceeds to the process of step S202. The first reference voltage is a voltage value that is determined based on a voltage required for stable sensing by the controller 10 using the sensor 8.

### (Step S202)

The source-of-electricity switching circuit 3 determines whether the voltage of the primary battery 4 is lower than a predetermined second reference voltage or not. When the source-of-electricity switching circuit 3 determines that the voltage of the primary battery 4 is lower than the second reference voltage (YES), the process proceeds to the process of step S211. In contrast, when the source-of-electricity switching circuit 3 determines that the voltage of the primary battery 4 is not lower than the second reference voltage (NO), the process proceeds to the process of step S203. The second reference voltage is another voltage value determined based on the voltage required for stable sensing by the controller 10 using the sensor 8.

### (Step S203)

The source-of-electricity switching circuit 3 switches the source of electricity for the power-supply IC 9 from the secondary battery 5 to the primary battery 4. It should be noted that after performing the process of step S203, the source-of-electricity switching circuit 3 performs any of the process of step S204A as indicated in FIG. 4, the process of step S204B as indicated in FIG. 5, the process of step S204C as indicated in FIG. 6, and the process of step S204D as indicated in FIG. 7.

### (Step S204A)

The source-of-electricity switching circuit 3 determines whether the number of times the source of electricity is switched to the primary battery 4 in a predetermined time period is larger than or equal to a predetermined reference number or not. When the source-of-electricity switching circuit 3 determines that the number of times the source of electricity is switched to the primary battery 4 in the predetermined time period is larger than or equal to the reference number (YES), the process proceeds to the process of step S205. In contrast, when the source-of-electricity switching circuit 3 determines that the number of times the source of electricity is switched to the primary battery 4 in the predetermined time period is neither larger than nor equal to the reference number (NO), the process proceeds to the process of step S206. The reference number is a value for use in determination whether the energy harvesting module 20 satisfactorily performs energy harvesting or not, that is, whether a requirement for energy harvesting by the energy harvesting module 20 is satisfied or not.

### (Step S204B)

The source-of-electricity switching circuit 3 determines whether the source of electricity is switched to the primary battery 4 is performed in a predetermined time period or not. When the source-of-electricity switching circuit 3 determines that the source of electricity is switched to the primary battery 4 in the predetermined time period (YES), the process proceeds to the process of step S205. In contrast, when the source-of-electricity switching circuit 3 determines that the source of electricity is not switched to the primary battery 4 in the predetermined time period (NO), the process proceeds to the process of step S206. The predetermined time period is a value for use in determination whether the energy harvesting module 20 satisfactorily performs energy harvesting or not, that is, whether the requirement for energy harvesting by the energy harvesting module 20 is satisfied or not.

### (Step S204C)

The source-of-electricity switching circuit 3 determines whether the amount of voltage reduction of the primary battery 4 in a predetermined time period is larger than or equal to a predetermined reference voltage reduction amount or not. When the source-of-electricity switching circuit 3 determines that the amount of voltage reduction of the primary battery 4 in the predetermined time period is larger than or equal to the reference voltage reduction amount (YES), the process proceeds to the process of step S205. In contrast, when the source-of-electricity switching circuit 3 determines that the amount of voltage reduction of the primary battery 4 in the predetermined time period is neither larger than nor equal to the reference voltage reduction amount (NO), the process proceeds to the process of step S206. The reference voltage reduction amount is a value for use in determination whether the energy harvesting module 20 satisfactorily performs energy harvesting or not, that is, whether the requirement for energy harvesting by the energy harvesting module 20 is satisfied or not.

### (Step 3204D)

The source-of-electricity switching circuit 3 determines whether the total time for which the primary battery 4 is used as the source of electricity in a predetermined time period is longer than or equal to a predetermined time or not. When the source-of-electricity switching circuit 3 determines that the total time for which the primary battery 4 is used as the source of electricity in the predetermined time period is longer than or equal to the predetermined time (YES), the process proceeds to the process of step S205. In contrast, when the source-of-electricity switching circuit 3 determines that the total time for which the primary battery 4 is used as the source of electricity in the predetermined time period is neither longer than nor equal to the predetermined time (NO), the process proceeds to the process of step S206. The predetermined time period and the predetermined time are values for use in determination whether the energy harvesting module 20 satisfactorily performs energy harvesting or not, that is, whether a requirement for energy harvesting by the energy harvesting module 20 is satisfied or not.

### (Step S205)

The controller 10 causes the notification unit 7 or an external device, which is connected via the wireless communication unit 6, to make a notification to the effect that the operation of the secondary battery 5 is unstable. This notification is indication of, for example, the message “[t]he primary battery is in use because the operation of the secondary battery is unstable.” It should be noted that both the notification unit 7 and the external device may be caused to make the above notification.

### (Step S206)

The source-of-electricity switching circuit 3 determines whether the voltage of the primary battery 4 is lower than a predetermined second reference voltage or not. When the source-of-electricity switching circuit 3 determines that the voltage of the primary battery 4 is lower than the second reference voltage (YES), the process proceeds to the process of step S208. In contrast, when the source-of-electricity switching circuit 3 determines that the voltage of the primary battery 4 is not lower than the second reference voltage (NO), the process proceeds to the process of step S207.

### (Step S207)

The source-of-electricity switching circuit 3 determines whether the voltage of the secondary battery 5 is higher than or equal to a predetermined third reference voltage or not. When the source-of-electricity switching circuit 3 determines that the voltage of the secondary battery 5 is higher than or equal to the third reference voltage (YES), the process proceeds to the process of step S209. In contrast, when the source-of-electricity switching circuit 3 determines that the voltage of the secondary battery 5 is neither higher than nor equal to the third reference voltage (NO), the process returns to the process of one of steps S204A to S204D. Although the third reference voltage and the first reference voltage may be equal to each other or different from each other, in the case where the third reference voltage is set to a value higher than the first reference voltage, it is possible to reduce the frequency of switching the source of electricity for the power-supply IC 9 between the primary battery 4 and the secondary battery 5.

### (Step S208)

The source-of-electricity switching circuit 3 sets a primary-battery voltage lowering flag to ON. Then, the sensor device 100 is subjected to a RESET process to enter the initial state. It should be noted that in the initial setting, the primary-battery voltage lowering flag is set to OFF. The information of the primary-battery voltage lowering flag is stored in a non-volatile semiconductor memory in the memory device 11.

### (Step S209)

The source-of-electricity switching circuit 3 switches the source of electricity for the power-supply IC 9 from the primary battery 4 to the secondary battery 5.

### (Step S210)

The controller 10 determines whether the primary-battery voltage lowering flag is set to ON or not. When the controller 10 determines that the primary-battery voltage lowering flag is set to ON (YES), the process proceeds to the process of step S211. In contrast, when the controller 10 determines that the primary-battery voltage lowering flag is set to OFF (NO), the process returns to the process of step S201.

### (Step S211)

The controller 10 causes the notification unit 7 or the external device, which is connected via the wireless communication unit 6, to make a notification to the effect that the primary battery 4 needs to be replaced. The notification is indication of the message, for example, “[p]lease replace the primary battery because it is exhausted.” It should be noted that both the notification unit 7 and the external device may be caused to make the above notification.

After the primary battery 4 is replaced, the primary-battery voltage lowering flag is set to OFF.

As described above, in the sensor device 100 according to Embodiment 2, after the source of electricity is switched to the primary battery 4, the controller 10 determines whether the number of times the source of electricity is switched to the primary battery 4 in the predetermined time period is larger than or equal to the predetermined reference number or not. Then, when the controller 10 determines that the number of times the source of electricity is switched to the primary battery 4 in the predetermined time period is larger than or equal to the predetermined reference number, the controller 10 causes the notification unit 7 or the external device to make a notification to the effect that the operation of the secondary battery 5 is unstable.

Alternatively, in the sensor device 100 according to Embodiment 2, after the source of electricity is switched to the primary battery 4, the controller 10 determines whether the source of electricity is switched to the primary battery 4 in the predetermined time period or not. Then, when the controller 10 determines that the source of electricity is switched to the primary battery 4 in the predetermined time period, the controller 10 causes the notification unit 7 or the external device to make a notification to the effect that the operation of the secondary battery 5 is unstable.

Alternatively, in the sensor device 100 according to Embodiment 2, after the source of electricity is switched to the primary battery 4, the controller 10 determines whether the amount of voltage reduction of the primary battery 4 in the predetermined time period is larger than or equal to the predetermined reference voltage reduction amount or not. Then, when the controller 10 determines that the amount of voltage reduction of the primary battery 4 in the predetermined time period is larger than or equal to the reference voltage reduction amount, the controller 10 causes the notification unit 7 or the external device to make a notification that the operation of the secondary battery 5 is unstable.

Alternatively, in the sensor device 100 according to Embodiment 2, after the source of electricity is switched to the primary battery 4, the controller 10 determines whether the total time for which the primary battery 4 is used as the source of electricity in the predetermined time period is longer than or equal to the predetermined time or not. Then, when the controller 10 determines that the total time for which the primary battery 4 is used as the source of electricity in the predetermined time period is longer than or equal to the predetermined time, the controller 10 causes the notification unit 7 or the external device to make a notification to the effect that the operation of the secondary battery 5 is unstable.

In the sensor device 100 according to Embodiment 2, when the above requirement is satisfied after the source of electricity is switched to the primary battery 4, the controller 10 causes the notification unit 7 or the external device to make a notification to the effect that the operation of the secondary battery 5 is unstable. It is therefore possible to prevent the controller 10 from causing the notification unit 7 or the external device to make a notification to the effect that the operation of the secondary battery 5 is unstable, even when the source of electricity is switched to the primary battery 4 for only a moment in the case where actually, the operation of the secondary battery 5 is stable. Then, the user can more accurately know, for example, whether the sensor device 100 is set in an optimal environment for energy harvesting.

### Embodiment 3

Regarding Embodiment 3, of the descriptions concerning Embodiment 1, descriptions that can be applied to Embodiment 1 will not be repeated, and components that are the same as or equivalent to those in Embodiment 1 will be denoted by the same reference signs.

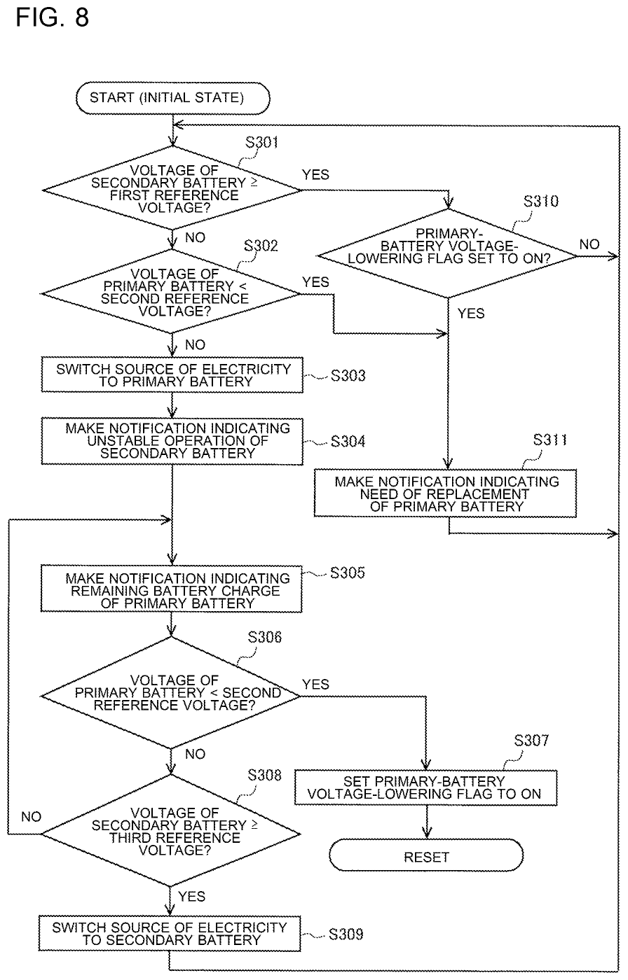

FIG. 8 indicates a control flow of a control by a sensor device 100 according to Embodiment 3. The control by the sensor device 100 according to Embodiment 3 will be described in detail with reference to FIG. 8.

In the initial state, the source of electricity for the power-supply IC 9 is the secondary battery 5.

### (Step S301)

The source-of-electricity switching circuit 3 determines whether the voltage of the secondary battery 5 is higher than or equal to a predetermined first reference voltage or not. When the source-of-electricity switching circuit 3 determines that the voltage of the secondary battery 5 is higher than or equal to the first reference voltage (YES), the process proceeds to the process of step S310. In contrast, when the source-of-electricity switching circuit 3 determines that the voltage of the secondary battery 5 is neither higher than nor equal to the first reference voltage (NO), the process proceeds to the process of step S302. The first reference voltage is a voltage value that is determined based on a voltage required for stable sensing by the controller 10 using the sensor 8.

### (Step S302)

The source-of-electricity switching circuit 3 determines whether the voltage of the primary battery 4 is lower than a predetermined second reference voltage or not. When the source-of-electricity switching circuit 3 determines that the voltage of the primary battery 4 is lower than the second reference voltage (YES), the process proceeds to the process of step S311. In contrast, when the source-of-electricity switching circuit 3 determines that the voltage of the primary battery 4 is not lower than the second reference voltage (NO), the process proceeds to the process of step S303. The second reference voltage is another voltage value determined based on the voltage required for stable sensing by the controller 10 using the sensor 8.

### (Step S303)

The source-of-electricity switching circuit 3 switches the source of electricity for the power-supply IC 9 from the secondary battery 5 to the primary battery 4.

### (Step S304)

The controller 10 causes the notification unit 7 or an external device, which is connected via the wireless communication unit 6, to make a notification to the effect that the operation of the secondary battery 5 is unstable. The notification is indication of, for example, the message “[t]he primary battery is in use because the operation of the secondary battery is unstable.” It should be noted that both the notification unit 7 and the external device may be caused to make the above notification.

### (Step S305)

The controller 10 causes the notification unit 7 or the external device, which is connected via the wireless communication unit 6, to make a notification indicating the remaining battery charge of the primary battery 4. The notification is indication of, for example, the message “[t]he remaining battery charge of the primary battery is 70%.” The remaining battery charge of the primary battery 4 is calculated based on, for example, the voltage of the primary battery 4. It should be noted that both the notification unit 7 and the external device may be caused to make the above notification.

### (Step S306)

The source-of-electricity switching circuit 3 determines whether the voltage of the primary battery 4 is lower than the predetermined second reference voltage or not. When the source-of-electricity switching circuit 3 determines that the voltage of the primary battery 4 is lower than the second reference voltage (YES), the process proceeds to the process of step S307. In contrast, when the source-of-electricity switching circuit 3 determines that the voltage of the primary battery 4 is not lower than the second reference voltage (NO), the process proceeds to the process of step S308.

### (Step S307)

The source-of-electricity switching circuit 3 sets a primary-battery voltage lowering flag to ON. Then, the sensor device 100 is subjected to a RESET process to enter the initial state. It should be noted that in the initial setting, the primary-battery voltage lowering flag is set to OFF. The information of the primary-battery voltage lowering flag is stored in a non-volatile semiconductor memory in the memory device 11.

### (Step S308)

The source-of-electricity switching circuit 3 determines whether the voltage of the secondary battery 5 is higher than or equal to a predetermined third reference voltage or not. When the source-of-electricity switching circuit 3 determines that the voltage of the secondary battery 5 is higher than or equal to the third reference voltage (YES), the process proceeds to the process of step S309. In contrast, when the source-of-electricity switching circuit 3 determines that the voltage of the secondary battery 5 is neither higher than nor equal to the third reference voltage (NO), the process returns to the process of step S305. Although the third reference voltage and the first reference voltage may be equal to each other or different from each other, in the case where the third reference voltage is set to a value higher than the first reference voltage, it is possible to reduce the frequency of switching the source of electricity for the power-supply IC 9 between the primary battery 4 and the secondary battery 5.

### (Step S309)

The source-of-electricity switching circuit 3 switches the source of electricity for the power-supply IC 9 from the primary battery 4 to the secondary battery 5.

### (Step S310)

The controller 10 determines whether the primary-battery voltage lowering flag is set to ON or not. When the controller 10 determines that the primary-battery voltage lowering flag is set to ON (YES), the process proceeds to the process of step S311. In contrast, when the controller 10 determines that the primary-battery voltage lowering flag is set to OFF (NO), the process returns to the process of step S301.

### (Step S311)

The controller 10 causes the notification unit 7 or the external device, which is connected via the wireless communication unit 6, to make a notification to the effect that the primary battery 4 needs to be replaced. The notification is indication of, for example, the message “[p]lease replace the primary battery because it is exhausted.” It should be noted that both the notification unit 7 and the external device may be caused to make the above notification.

After the primary battery 4 is replaced, the primary-battery voltage lowering flag is set to OFF.

As described above, in the sensor device 100 according to Embodiment 3, the source-of-electricity switching circuit 3 calculates the remaining battery charge of the primary battery 4 based on the voltage of the primary battery 4, and the controller 10 causes the notification unit 7 or the external device to make a notification indicating the remaining battery charge of the primary battery 4.

In the sensor device 100 according to Embodiment 3, the controller 10 causes the notification unit 7 or the external device to make a notification indicating the remaining battery charge of the primary battery 4. Thus, the user can view the remaining battery charge of the primary battery 4 and thus prepare a new primary battery by which the primary battery 4 is replaced, if necessary, or recognize that the energy harvesting module 20 does not satisfactorily perform energy harvesting, when the battery level of the primary battery 4 rapidly drops.

### Embodiment 4

Regarding Embodiment 4, of the descriptions concerning Embodiment 1, descriptions that can also be applied to Embodiment 4 will not be repeated, and components that are the same as or equivalent to those in Embodiment 1 will be denoted b the same reference signs.

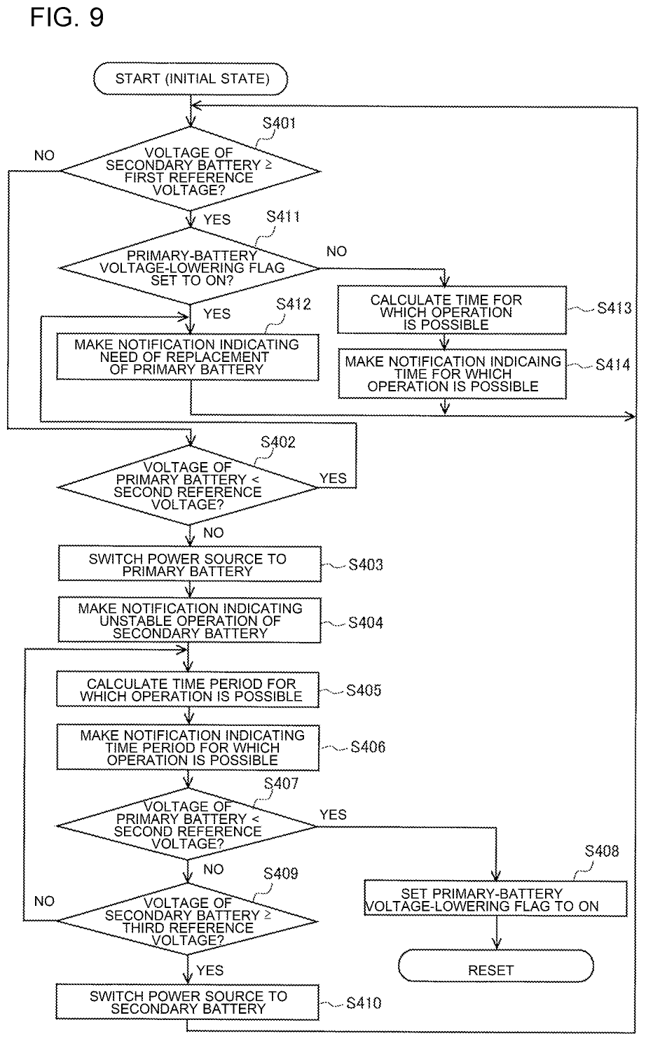

FIG. 9 indicates a control flow of a control by a sensor device 100 according to Embodiment 4. The control by the sensor device 100 according to Embodiment 4 will be described in detail with reference to FIG. 9.

In the initial state, the source of electricity for the power-supply IC 9 is the secondary battery 5.

### (Step S401)

The source-of-electricity switching circuit 3 determines whether the voltage of the secondary battery 5 is higher than or equal to a predetermined first reference voltage. When the source-of-electricity switching circuit 3 determines that the voltage of the secondary battery 5 is higher than or equal to the first reference voltage (YES), the process proceeds to the process of step S411. In contrast, when the source-of-electricity switching circuit 3 determines that the voltage of the secondary battery 5 is neither higher than nor equal to the first reference voltage (NO), the process proceeds to the process of step S402. The first reference voltage is a voltage value that is determined based on a voltage required for stable sensing by the controller 10 using the sensor 8.

### (Step S402)

The source-of-electricity switching circuit 3 determines whether the voltage of the primary battery 4 is lower than a predetermined second reference voltage or not. When the source-of-electricity switching circuit 3 determines that the voltage of the primary battery 4 is lower than the second reference voltage (YES), the process proceeds to the process of step S412. In contrast, when the source-of-electricity switching circuit 3 determines that the voltage of the primary battery 4 is not lower than the second reference voltage (NO), the process proceeds to the process of step S403. The second reference voltage is another voltage value determined based on the voltage required for stable sensing by the controller 10 using the sensor 8.

### (Step S403)

The source-of-electricity switching circuit 3 switches the source of electricity for the power-supply IC 9 from the secondary battery 5 to the primary battery 4.

### (Step S404)

The controller 10 causes the notification unit 7 or an external device, which is connected via the wireless communication unit 6, to make a notification to the effect that the operation of the secondary battery 5 is unstable. The notification is indication of, for example, the message “[t]he primary battery is in use because the operation of the secondary battery is unstable.” It should be noted that both the notification unit 7 and the external device may be caused to make the above notification.

### (Step S405)

The source-of-electricity switching circuit 3 calculates time for which the sensor device 100 can operate. For example, the source-of-electricity switching circuit 3 measures a value of current that flows from the primary battery 4 to the source-of-electricity switching circuit 3 when the source of electricity for the power-supply IC 9 is the primary battery 4. Next, the source-of-electricity switching circuit 3 calculates electricity consumption of the primary battery 4, on which the above current-value measurement is performed. Then, the source-of-electricity switching circuit 3 determines time for which the primary battery 4 is used for the source of electricity in a predetermined time period, and calculates electricity consumption of the primary battery 4 in the predetermined time period. Subsequently, the source-of-electricity switching circuit 3 calculates time for which the sensor device 100 can operate, based on the calculated electricity consumption and the remaining battery charge of the primary battery 4 that is calculated based on, for example, the voltage of the primary battery 4, The time for which the sensor device 100 can operate may be calculated based on a design value for the sensor device 100. Specifically, the time for which the sensor device 100 can operate is calculated based on both electricity consumption that is determined from the design value for the sensor device 100, and a use ratio between the primary battery 4 and the secondary battery 5 in the case where the sensor device 100 is used under an expected condition.

### (Step S406)

The controller 10 causes the notification unit 7 or the external device, which is connected via the wireless communication unit 6, to make a notification indicating the time for which the sensor device 100 can operate. The notification is indication of, for example, the message “[t]he sensor device can operate for 5 hours.” When the calculated time for which the sensor device 100 can operate is shorter than the expected time, it is conceivable that the sensor device 100 is not set in an optimal environment for energy harvesting. Thus, the notification unit 7 or the external device, which is connected via the wireless communication unit 6, may be caused to make a notification to the effect that the sensor device 100 is not set in an optimal environment for energy harvesting. Both the notification unit 7 and the external device may be caused to make the above notification,

### (Step S407)

The source-of-electricity switching circuit 3 determines whether the voltage of the primary battery 4 is lower than the predetermined second reference voltage or not. When the source-of-electricity switching circuit 3 determines that the voltage of the primary battery 4 is lower than the second reference voltage (YES), the process proceeds to the process of step S408. In contrast, when the source-of-electricity switching circuit 3 determines that the voltage of the primary battery 4 is not lower than the second reference voltage (NO), the process proceeds to the process of step S409.

### (Step S408)

The source-of-electricity switching circuit 3 sets a primary-battery voltage lowering flag to ON. Then, the sensor device 100 is subjected to a RESET process to enter the initial state. It should be noted that in the initial setting, the primary-battery voltage lowering flag is set to OFF. The information of the primary-battery voltage lowering flag is stored in a non-volatile semiconductor memory in the memory device 11.

### (Step S409)

The source-of-electricity switching circuit 3 determines whether the voltage of the secondary battery 5 is higher than or equal to a predetermined third reference voltage or not. When the source-of-electricity switching circuit 3 determines that the voltage of the secondary battery 5 is higher than or equal to the third reference voltage (YES), the process proceeds to the process of step S410. In contrast, when the source-of-electricity switching circuit 3 determines that the voltage of the secondary battery 5 is neither higher than nor equal to the third reference voltage (NO), the process returns to process of step S405. Although the third reference voltage and the first reference voltage may be equal to each other or different from each other, in the case where the third reference voltage is set to a value higher than the first reference voltage, it is possible to reduce the frequency of switching the source of electricity for the power-supply IC 9 between the primary battery 4 and the secondary battery 5.

### (Step S410)

The source-of-electricity switching circuit 3 switches the source of electricity for the power-supply IC 9 from the primary battery 4 to the secondary battery 5.

### (Step S411)

The controller 10 determines whether the primary-battery voltage lowering flag is set to ON or not. When the controller 10 determines that the primary-battery voltage lowering flag is set to ON (YES). the process proceeds to the process of step S412. In contrast, when the controller 10 determines that the primary-battery voltage lowering flag is set to OFF (NO), the process proceeds to the process of step S413.

### (Step S412)

The controller 10 causes the notification unit 7 or the external device, which is connected via the wireless communication unit 6, to make a notification to the effect that the primary battery 4 needs to be replaced. The notification is indication of, for example, the message “[p]lease replace the primary battery because it is exhausted.” Both the notification unit 7 and the external device may be caused to make the above notification.

After the primary battery 4 is replaced, the primary-battery voltage lowering flag is set to OFF.

### (Step S413)

The source-of-electricity switching circuit 3 calculates time for which the sensor device 100 can operate. For example, the source-of-electricity switching circuit 3 measures a value of current that flows from the secondary battery 5 to the source-of-electricity switching circuit 3 when the source of electricity for the power-supply IC 9 is the secondary battery 5. Next, the source-of-electricity switching circuit 3 calculates electricity consumption of the secondary battery 5, using the measured value of current that flows from the secondary battery 5. Then, since the self-electricity-consumption of the primary battery 4 and the self-electricity-consumption of the secondary battery 5 are different from each other, the source-of-electricity switching circuit 3 corrects the calculated electricity consumption of the secondary battery 5 based on the above difference in self-electricity-consumption to calculate the electricity consumption of the primary battery 4. Next, the source-of-electricity switching circuit 3 determines time for which that the secondary battery 5 is used as the source of electricity in a predetermined time period, and calculates the electricity consumption of the secondary battery 5 in the predetermined time period. Then, the source-of-electricity switching circuit 3 calculates time for which the sensor device 100 can operate, based on the calculated electricity consumption and the remaining battery charge of the primary battery 4. The time for which the sensor device 100 can operate may be calculated based on a design value for the sensor device 100. Specifically, the time for which the sensor device 100 can operate is calculated based on both electricity consumption, which is determined from the design value for the sensor device 100, and a use ratio between the primary battery 4 and the secondary battery 5 in the case where the sensor device 100 is used under an expected condition.

### (Step S414)

The controller 10 causes the notification unit 7 or the external device, which is connected via the wireless communication unit 6, to make a notification indicating the time which the sensor device 100 can operate. The notification is indication of, for example, the message “[t]he sensor device can operate for 5 hours.” When the time for which the sensor device 100 can operate is shorter than an expected time, it is conceivable that the sensor device 100 is not set in an optimal environment for energy harvesting. Thus, the notification unit 7 or the external device, which is connected via the wireless communication unit 6, may be caused to make a notification to the effect that the sensor device 100 is not set in an optimal environment for energy harvesting. It should be noted that both the notification unit 7 and the external device may be caused to make the above notification.

As described above, in the sensor device 100 according to Embodiment 4, the source-of-electricity switching circuit 3 calculates the electricity consumption of the primary battery 4 in the predetermined time period based on the current of the primary battery 4 or the current of the secondary battery 5, and calculates time for which the sensor device 100 can operate, based on the calculated electricity consumption and the remaining battery charge of the primary battery 4. Then, the controller 10 causes the notification unit 7 or the external device to make a notification indicating the time for which the sensor device 100 can operate.

In the sensor device 100 according to Embodiment 4, the controller 10 causes the notification unit 7 or the external device to make a notification indicating the calculated time for which the sensor device 100 can operate. Thus, the user can confirm the time for which the sensor device 100 can operate, and thus prepare a new battery by which the primary battery 4 is replaced, if necessary, or recognize that the energy harvesting module 20 does not satisfactorily perform energy harvesting in the case where the time for which the sensor device 100 can operate is shorter than the expected time.

Processes described regarding Embodiments 1 to 4 may be combined as appropriate.

It is described above that the sensor device 100 according to each of Embodiments 1 to 4 includes the primary battery 4 and the secondary battery 5 as the sources of electricity for the power-supply IC 9, and switches the source of electricity for the power-supply IC 9 between the primary battery 4 and the secondary battery 5, depending on a situation; however, it is not limiting. The sensor device 100 may include two secondary batteries 5 as the sources of electricity for the power-supply IC 9, and switch the source of electricity for the power-supply IC 9 between the two secondary batteries 5 depending on a situation. It should be noted that in the case where two secondary batteries 5 are provided, the two secondary batteries 5 may be the same type of source of energy or different types of sources of energy.

### REFERENCE SIGNS LIST

2: sensor device board, 3: source-of-electricity switching circuit, 3a: switching control unit, 3b: switching unit, 3c: voltage detection circuit, 3d: current detection circuit, 4: primary battery, 5: secondary battery, 6: wireless communication unit, 7: notification unit, 8: sensor, 9: power-supply IC, 10: controller, 11: memory device, 20: energy harvesting module, 21: energy harvesting unit, 22: energy harvesting circuit, 100: sensor device

1. A sensor device comprising:
a primary battery;
a secondary battery that is charged by energy harvesting;
a sensor configured to be operated by electricity supplied from the primary battery or from the secondary battery;
a source-of-electricity switching circuit configured to switch a source of electricity for the sensor between the primary battery and the secondary battery;
a notification unit configured to make a notification indicating information; and
a controller configured to control the sensor and the notification unit,
wherein the source-of-electricity switching circuit is configured to switch the source of electricity to the primary battery when a voltage of the secondary battery falls below a predetermined first reference voltage in a case where the source of electricity is the secondary battery, and
wherein the controller is configured to cause the notification unit to make a notification indicating that an operation of the secondary battery is unstable, when the voltage of the secondary battery falls below the first reference voltage, and
the controller is configured to cause the notification unit to make a notification indicating that the primary battery needs to be replaced, when a voltage of the primary battery is lower than a predetermined second reference voltage in a case where the source of electricity is the secondary battery.

2. A sensor device comprising:
a primary battery;
a secondary battery that is charged by energy harvesting;
a sensor configured to be operated by electricity supplied from the primary battery or from the secondary battery;
a source-of-electricity switching circuit configured to switch a source of electricity for the sensor between the primary battery and the secondary battery;
a wireless communication unit configured to wirelessly communicate with an external device and transmit information to be indicated by a notification that the external device is caused to make; and
a controller configured to control the sensor and the wireless communication unit,
wherein the source-of-electricity switching circuit is configured to switch the source of electricity to the primary battery when a voltage of the secondary battery falls below a predetermined first reference voltage in a case where the source of electricity is the secondary battery, and
wherein the controller is configured to cause the external device to make a notification indicating that an operation of the secondary battery is unstable, when the voltage of the secondary battery falls below the first reference voltage, and
the controller is configured to cause the external device to make a notification indicating that the primary battery needs to be replaced, when a voltage of the primary battery is lower than a predetermined second reference voltage in a case where the source of electricity is the secondary battery.

3. (canceled)

4. The sensor device of claim 1, wherein the controller is configured to, after the source of electricity is switched to the primary battery:
determine whether the number of times the source of electricity is switched to the primary battery in a predetermined time period is larger than or equal to a predetermined reference number or not; and
cause the notification unit to make a notification indicating that the operation of the secondary battery is unstable, when the controller determines that the number of times the source of electricity is switched to the primary battery in the predetermined time period is larger than or equal to the predetermined reference number.

5. The sensor device of claim 1, wherein the controller is configured to, after the source of electricity is switched to the primary battery:
determine whether the source of electricity is switched to the primary battery in a predetermined time period or not; and
cause the notification unit to make a notification indicating that the operation of the secondary battery is unstable, when the controller determines that the source of electricity is switched to the primary battery in the predetermined time period.

6. The sensor device of claim 1, wherein the controller is configured to, after the source of electricity is switched to the primary battery:
determine whether an amount of voltage reduction of the primary battery in a predetermined time period is larger than or equal to a predetermined reference voltage reduction amount or not; and
cause the notification unit to make a notification indicating that the operation of the secondary battery is unstable, when the controller determines that the amount of voltage reduction of the primary battery in the predetermined time period is larger than or equal to the predetermined reference voltage reduction amount.

7. The sensor device of claim 1, wherein the controller is configured to, after the source of electricity is switched to the primary battery:
determine whether a total time for which the primary battery is used as the source of electricity in a predetermined time period is longer than or equal to a predetermined time or not, and
cause the notification unit to make a notification indicating that the operation of the secondary battery is unstable, when the controller determines that the total time for which the primary battery is used as the source of electricity in the predetermined time period is longer than or equal to the predetermined time.

8. The sensor device of claim 1, wherein
the source-of-electricity switching circuit is configured to calculate a remaining battery capacity of the primary battery based on the voltage of the primary battery, and
the controller causes the notification unit to make a notification indicating the remaining battery charge of the primary battery.

9. The sensor device of claim 1, wherein
the source-of-electricity switching circuit is configured to calculate an electricity consumption of the primary battery in a predetermined time period based on a current of the primary battery or a current of the secondary battery, and calculates time for which the sensor device is allowed to operate, based on the calculated electricity consumption and a remaining battery charge of the primary battery, and
the controller is configured to cause the notification unit to make a notification indicating the calculated time for which the sensor device is allowed to operate.

10. The sensor device of claim 2, wherein the controller is configured to, after the source of electricity is switched to the primary battery:
determine whether the number of times the source of electricity is switched to the primary battery in a predetermined time period is larger than or equal to a predetermined reference number or not; and
cause the external device to make a notification indicating that the operation of the secondary battery is unstable, when the controller determines that the number of times the source of electricity is switched to the primary battery in the predetermined time period is larger than or equal to the predetermined reference number.

11. The sensor device of claim 2, wherein the controller is configured to, after the source of electricity is switched to the primary battery:
determine whether the source of electricity is switched to the primary battery in a predetermined time period or not; and
cause the external device to make a notification indicating that the operation of the secondary battery is unstable, when the controller determines that the source of electricity is switched to the primary battery in the predetermined time period.

12. The sensor device of claim 2, wherein the controller is configured to, after the source of electricity is switched to the primary battery:
determine whether an amount of voltage reduction of the primary battery in a predetermined time period is larger than or equal to a predetermined reference voltage reduction amount or not; and
cause the external device to make a notification indicating that the operation of the secondary battery is unstable, when the controller determines that the amount of voltage reduction of the primary battery in the predetermined time period is larger than or equal to the predetermined reference voltage reduction amount.

13. The sensor device of claim 2, wherein the controller is configured to, after the source of electricity is switched to the primary battery:
determine whether a total time for which the primary battery is used as the source of electricity in a predetermined time period is longer than or equal to a predetermined time or not, and
cause the external device to make a notification indicating that the operation of the secondary battery is unstable, when the controller determines that the total time for which the primary battery is used as the source of electricity in the predetermined time period is longer than or equal to the predetermined time.

14. The sensor device of claim 2, wherein
the source-of-electricity switching circuit is configured to calculate a remaining battery capacity of the primary battery based on the voltage of the primary battery, and
the controller is configured to cause the external device to make a notification indicating the remaining battery charge of the primary battery.

15. The sensor device of claim 2, wherein
the source-of-electricity switching circuit is configured to calculate an electricity consumption of the primary battery in a predetermined time period based on a current of the primary battery or a current of the secondary battery, and calculate time for which the sensor device is allowed to operate, based on the calculated electricity consumption and a remaining battery charge of the primary battery, and
the controller is configured to cause the external device to make a notification indicating the calculated time for which the sensor device is allowed to operate.
